(19) United States
(12) Patent Application Publication
(10) Pub. No.: US 2009/0061255 A1
(43) Pub. Date: Mar. 5, 2009

(54) BLOCK POLYMER, COMPOSITE OF METAL AND BLOCK POLYMER, AND DEVICE

(75) Inventors: Takeyuki Sone, Tokyo (JP); Otto Albrecht, Atsugi-shi (JP); Akira Kuriyama, Atsugi-shi (JP); Koji Yano, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/197,490

(22) Filed: Aug. 25, 2008

(30) Foreign Application Priority Data
Aug. 31, 2007 (JP) 2007-227018

(51) Int. Cl. B32B 27/28; C08L 53/00

(52) U.S. Cl. 428/689; 525/88

(57) ABSTRACT

A composite having a metal substance bonded to a block polymer. The composite is capable of electric bonding via the metallic substance. A device in which a pair of electrodes are connected via a polymer chain of the block polymer. The block polymer has in at least a part thereof a block structure of a repeating unit that has in a side chain thereof an organic functional group for bonding to at least one of the metallic entities. The polymer main chain of the block structure has a helical shape. In the composite of a metal and the block polymer, a part of the block structure of the block polymer is bonded to the metal species. In the device having the block polymer and an electrode composed of the metallic substance, a part of the block structure of the block polymer is bonded to the metallic substance.

### BACKGROUND OF THE INVENTION

1. Field of the Invention

The present invention relates to a block polymer, a composite of a metal and a block polymer, and a device.

2. Description of the Related Art

With an increase in the degree of integration of electronic circuits, organic devices using conductive organic substances, such as organic semiconductors, are attracting attention. The advantages of organic devices include their ability to bend and to be produced inexpensively, particularly where a film can be obtained from a solution, and for large-area devices.

The conventional organic semiconductors include low-molecular organic semiconductors, such as pentacene, and polymer semiconductors, such as polythiophenes. Because polymer semiconductors have especially good affinity for a solution process, they have attracted attention as conductive materials for fabricating large-area and low-cost devices.

Organic polymers are typically in the shape of a ball of thread, but π-conjugated polymers, such as substituted polyacetylenes or polydiacetylenes and poly(phenylene ethynylene), are typically rigid molecules. Furthermore, non-rigid polymers also demonstrate a shape close to an elongated chain, rather than a ball of thread, in terms of the crystal structure or the orientation state thereof. Such linear molecules, in particular π-conjugated polymers, can be expected to function, in principle, as monomolecular electronic devices when they are bonded at both ends thereof to electrodes. A problem encountered in this case is associated with the bonding of an organic molecule to electrodes. In presently available organic devices, a certain electric bonding is achieved by a physical contact when a metal is vapor-deposited as an electrode on an organic molecule or a film of an organic molecule is produced on an electrode. However, such electric bonding at the interface of the molecule and the electrode is a significant problem for organic devices.

Accordingly, a technology is required to achieve a chemical rather than a physical bond between a conjugated polymer and an electrode to obtain a stronger bonding of the end portion of the conjugated polymer to the electrode and inhibit the negative effect of the interface on electric bonding.

A system using a gold-thiol bond has been reported as a technique for bonding an organic molecule to an electrode. For example, Japanese Patent Laid-open No. 6-163049 describes an organic battery using a conductive material obtained by introducing a thiol into a side chain of an acrylic polymer and a methacrylic polymer in an electrode as an application example of polymers in which a thiol is introduced into a side chain. However, a large number of issues relating to a gold-thiol bond have not been clarified, and a different method for bonding an organic molecule to an electrode is still needed.

### SUMMARY OF THE INVENTION

The present invention provides a block polymer for bonding to a metallic substance.

The present invention also provides a composite in which a block polymer is bonded to a metallic substance. Because the composite enables electric bonding via a metallic substance, the present invention provides a device in which one molecule bridges a plurality of electrodes by connecting a pair of electrodes via a polymer chain of the block polymer.

A block polymer in accordance with the present invention has in at least a part thereof a block structure of a repeating unit that has in a side chain thereof an organic functional group capable of bonding to at least one metallic substance selected from a metal, a metal oxide, and an alloy. This polymer main chain of the block structure has a helical shape.

A composite of a metal and a block polymer in accordance with present invention comprises the above-described block polymer and a metallic substance selected from a metal, a metal oxide, and an alloy. A part of a block structure of the block polymer is bonded to the metallic substance.

A device in accordance with the present invention comprises the above-described block polymer and an electrode comprising a metallic substance selected from a metal, a metal oxide, and an alloy. A part of a block structure of the block polymer is bonded to the metallic substance.

Further, a device may include the above-described block polymer, nanoparticles comprising a metallic substance selected from a metal, a metal oxide, and an alloys, and two or more electrodes. A part of a block structure of the block polymer is bonded to the nanoparticles comprising the metallic substance, and the block polymer and the nanoparticles comprising the metallic substance are connected to the electrode.

Other features of the present invention will become apparent from the following description of exemplary embodiments with reference to the attached drawings.

### BRIEF DESCRIPTION OF THE DRAWINGS

FIG. 1A is schematic drawing illustrating an embodiment of a block polymer in accordance with the present invention.

FIG. 1B is a schematic drawing illustrating an embodiment of a block polymer in accordance with the present invention.

FIG. 2 is a schematic drawing illustrating an embodiment of a composite of a metal and a block polymer in accordance with the present invention.

FIG. 3A is a schematic drawing illustrating an embodiment of a device in accordance with the present invention.

FIG. 3B is a schematic drawing illustrating an embodiment of a device in accordance with the present invention.

FIG. 4A is a schematic drawing illustrating another embodiment of a device in accordance with the present invention.

FIG. 4B is a schematic drawing illustrating another embodiment of a device in accordance with the present invention.

FIG. 4C is a schematic drawing illustrating another embodiment of a device in accordance with the present invention.

FIG. 5A is a schematic drawing illustrating another embodiment of a device in accordance with the present invention.

FIG. 5B is a schematic drawing illustrating another embodiment of a device in accordance with the present invention.

FIG. 6 is a schematic drawing illustrating another embodiment of a device in accordance with the present invention.

FIG. 7 is a schematic drawing illustrating another embodiment of a device in accordance with the present invention.

FIG. 8 is a schematic drawing illustrating another embodiment of a device in accordance with the present invention.

### DESCRIPTION OF THE EMBODIMENTS

A block polymer in accordance with the present invention has in at least a part thereof a block structure of a repeating unit that has in a side chain thereof an organic functional group that is capable of bonding to at least one metallic substance selected from a metal, a metal oxide, and an alloy. The polymer main chain of the block structure has a helical shape.

The organic functional group is preferably at least one group selected from a thiol group, a sulfide group, a disulfide group, a thioacetyl group, an isocyanide group, a carboxylic acid group, and a phosphoric acid group.

The metal is preferably gold, platinum, silicon, ITO (indium tin oxide), silicon oxide, or an alloy of gold and zinc.

The polymer main chain of the block structure of the repeating unit having the organic functional group preferably comprises a π-conjugated polymer.

The composite of a metal and a block polymer in accordance with the present invention comprises the above-described block polymer and a metallic substance selected from a metal, a metal oxide, and an alloy. A part of a block structure of the block polymer is bonded to the metallic substance.

The block polymer is preferably polyacetylene.

The metallic substance is preferably in the form of nanoparticles.

A device in accordance with the present invention includes the above-described block polymer and an electrode comprising a metallic substance selected from a metal, a metal oxide, and an alloy. A part of a block structure of the block polymer is bonded to the metallic substance.

The block polymer is preferably a polyacetylene.

Another device in accordance with the present invention comprises the above-described block polymer, nanoparticles comprising a metallic substance selected from a metal, a metal oxide, and an alloy and two or more electrodes. A part of a block structure of the block polymer is bonded to the nanoparticles comprising the metallic substance, and the block polymer and the nanoparticles comprising the metallic substance are connected to the electrode.

The present invention is described below in greater detail.

The inventors discovered that a block polymer with an improved ability to bond to an electrically conductive surface can be obtained by introducing into a part of a block polymer an organic functional group that is capable of bonding to an electrically conductive surface of a metal, a metal oxide, or an alloy. Examples of such groups include a thiol group, a sulfide group, a disulfide group, a thioacetyl group, an isocyanide group, a carboxylic acid group, and a phosphoric acid group, all of which have a good ability of bonding to, for example, gold.

Further, it was found that a composite of a metal and a block polymer can be obtained by contacting such a block polymer with and bonding it to a metallic substance. In this composite, functional groups, such as thiol groups, bond to the metallic substance at a plurality of locations, rather than at one location. Therefore, bonding that is strong both mechanically and electrically can be achieved.

Polymer semiconductors have been actively studied in Japan and other countries so that they can be applied in a field-effect transistor (FET) and the like. The mobility of carriers in polymers can be separately considered as that within a molecule and that between the molecules. Within the molecule, the carriers can move at a very high speed, whereas the speed of carrier movement between the molecules is apparently controlled by the hopping movement. As a result, a very high speed of carrier movement can potentially be achieved in a device comprising only one molecule, but such devices have not yet been obtained.

In the composite of a metal and a block polymer in accordance with the present invention, a part of the block polymer that is a channel portion of conductive carriers is chemically bonded to the surface of a metallic substance. As a result, an electrode can be attached at any position in the molecule and a device operating with only one molecule of a block polymer can be obtained. Another is that since a plurality of portions in a molecule of a block polymer in accordance with the present invention can be bonded to a conductive surface, two-terminal and three-terminal molecular devices can be obtained.

The block polymer in accordance with the present invention is explained below.

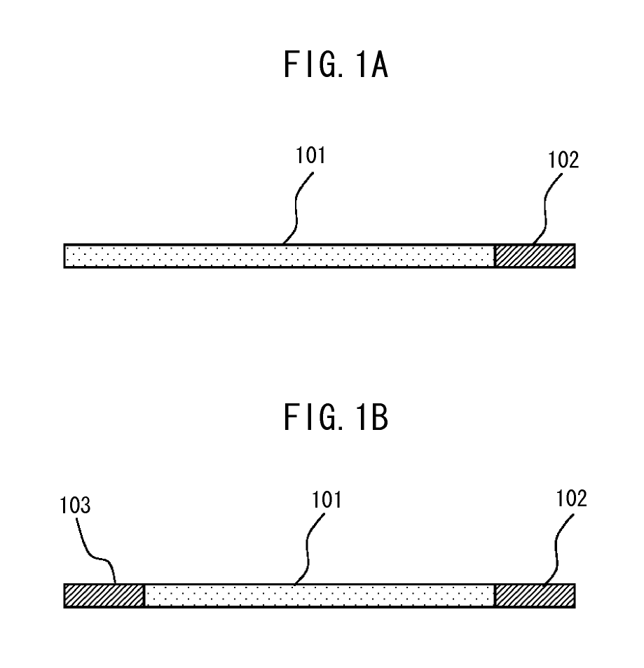

FIGS. 1A and 1B are schematic drawings illustrating an embodiment of the block polymer in accordance with the present invention. In FIGS. 1A and 1B, reference numerals 102 and 103 represent block structures in which an organic functional group with a good ability to bond to a metallic substance is introduced into a side chain. Reference numeral 101 represents a polymer chain having no organic functional groups. The block structure with organic functional groups having a good ability to bond to a metallic substance may be at one location, as shown in FIG. 1A, or at two or more locations, as shown in FIG. 1B. This block structure may be disposed at any location. However, a position at the chain end is preferred. In this case, the block structures 102 and 103 may be identical or different.

Examples of a metallic substance include metals, such as gold, platinum, and silicon, metal oxides, such as ITO and silicon oxide, and an alloy of gold and zinc. The metallic substance is not limited to a bulk material and may be film-shaped or in powder form.

Examples of organic functional groups include a thiol group, a sulfide group, a disulfide group, a thioacetyl group, an isocyanide group, a carboxylic acid group, and a phosphoric acid group.

Examples of organic functional groups that have a good ability of bonding to gold or alloys of gold and zinc include a thiol group (—SH), a sulfide group (—S—R), a dithiol group (—S—S—R), and a thioacetyl group (—C(O)—S—R). An isocyanide group (—CN) is a functional group that has a good ability of bonding to gold and platinum. Examples of functional groups that have a good ability of bonding to silicon include halogenated silyl groups (X₃—Si—, X₂—Si(R)—, X—Si(R₂)—), an aldehyde group (—CHO) and a vinyl group (H₂C═CH—). Examples of functional groups having a good ability of bonding to ITO include a carboxylic acid group (—C(O)—O—H) and a phosphoric acid group (—P(O)₂—O—H). A trialkoxysilane ((RO)₃—Si—) is a functional group that has a good ability of bonding to silicon oxide. A halogenided silyl group (XR₂—Si—) is a functional group that has good ability of bonding to silicon. In the above structures, R is an alkyl chain and X is a halogen atom.

The block polymer can be a block copolymer in which the polymer main chain of the block structure has a helical shape. The polymer main chain of the block structure of repeating units preferably comprises a π-conjugated polymer.

A method for manufacturing the block polymer is not particularly limited. For example, the manufacturing method can include the steps of growing a polysubstituted acetylene by using a mononuclear rhodium complex, which is a living polymerization catalyst of monosubstituted acetylene, and then adding an acetylene monomer having introduced therein a functional group that can be bonded to a specific solid surface. For example, a poly((phenylyacetylene)-co-(mercaptophenylacetylene)) block polymer having a phenyl group and a mercaptophenyl group in a side chain can be manufactured by block copolymerization using phenylacetylene and mercaptophenylacetylene as acetylene monomers.

An acetylene monomer can be used as a monomer for the manufacture of the block polymer.

In addition to nonpolar solvents, such as chloroform, tetrahydrofuran, and toluene, polar solvents, such as dimethylformamide, can also be used as polymerization solvents. These solvents can be used individually or in mixtures.

Formula (1) below represents an example of a polymerization catalyst for a substituted acetylene:

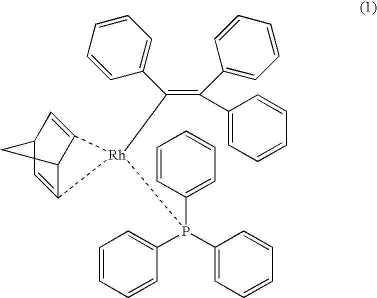

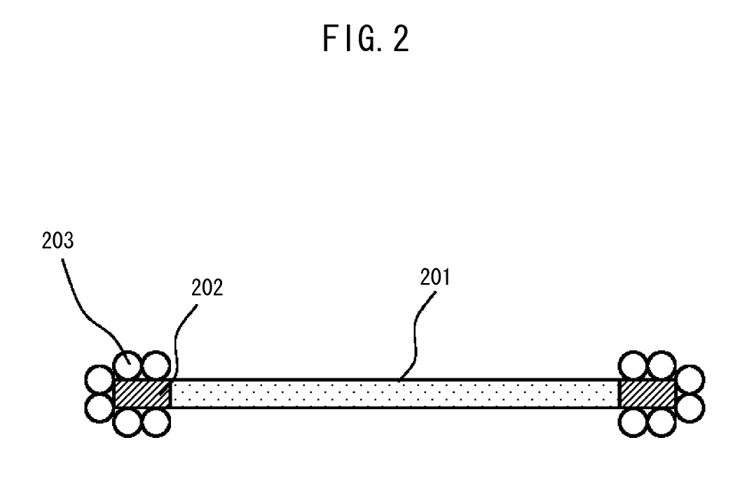

FIG. 2 is a schematic drawing illustrating an embodiment of the composite of a metal and a block polymer in accordance with the present invention. As shown in FIG. 2, when, for example, nanoparticles of any one of a metal, a metal oxide, and an alloy are brought into contact with a block polymer having organic functional groups that can be bonded to the nanoparticles, a composite is obtained in which nanoparticles 203 are bonded to a specific block 202 within the block polymer 201. The block polymer is preferably polyacetylene.

In such a composite, good contact between the molecule and the external electrode is obtained due to electric bonding via the nanoparticles of a metal, a metal oxide, or an alloy. Further, good contact between the molecules is obtained due to electric bonding between the nanoparticles in bulk, and the electric characteristics of the entire bulk are improved.

The device in accordance with the present invention comprises the above-described block polymer and an electrode comprising a metallic substance selected from a metal, a metal oxide, and an alloy. A part of a block structure of the block polymer is bonded to the metallic substance.

A device in which a block polymer having a specific organic functional group is covered on a base material having a solid surface that can be bonded to the organic functional group can be manufactured, for example, by dissolving the block polymer in a good organic solvent, mixing the solution with the base material and allowing the mixture to stand.

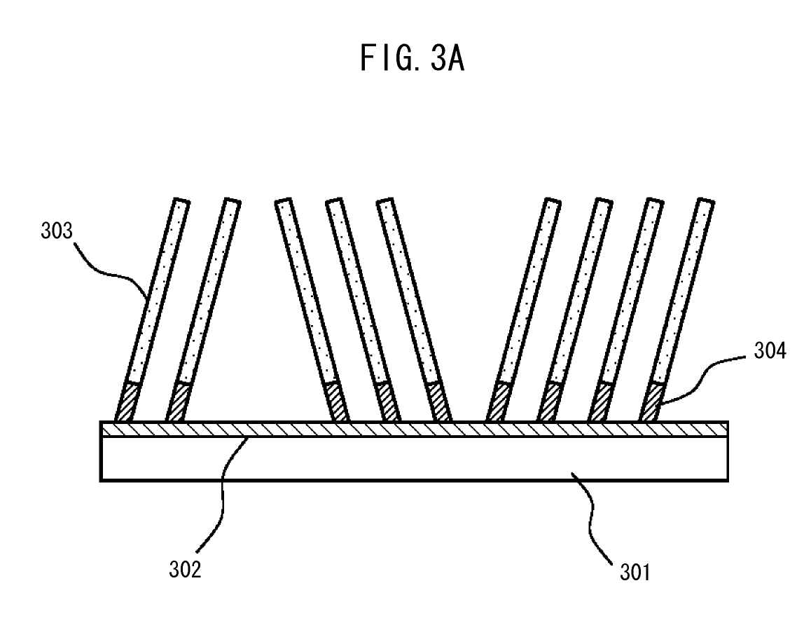

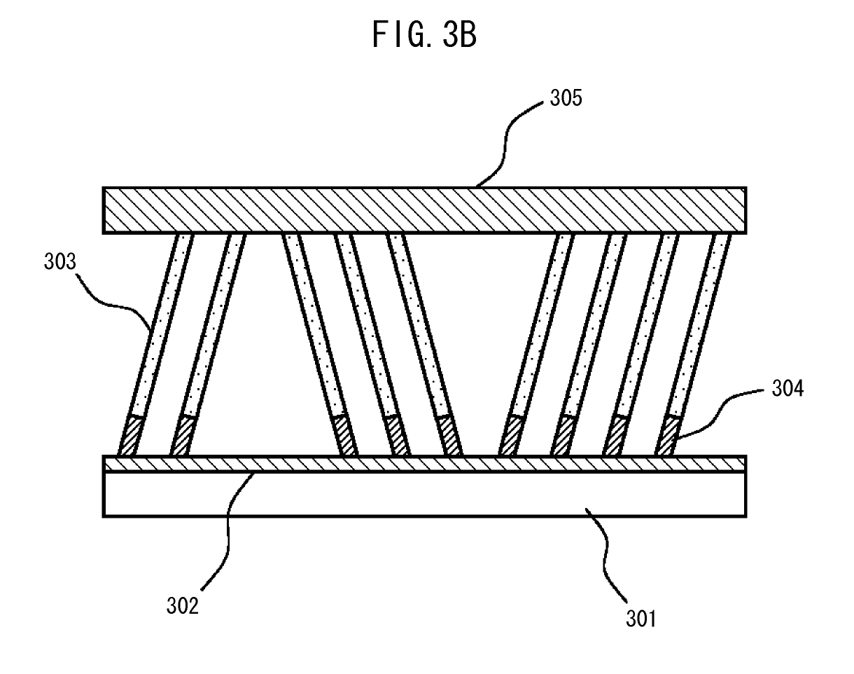

FIGS. 3A and 3B are schematic drawings illustrating an embodiment of a device in accordance with the present invention. In FIGS. 3A and 3B, reference symbol 301 represents a substrate, 302—a metallic substance, 303—a block polymer, 304—a block that can be bonded to the metallic substance and 305—an electrode.

FIG. 3A, a film device is obtained by producing a block polymer, which has a side chain, for example, a thiol group, that can be bonded to gold in the block structure thereof, dissolving the block polymer in a good solvent to form a solution, and immersing in this solution a base material having a gold surface, for example, a mica substrate with one vapor-deposited gold surface, thereby bonding gold and the thiol group and aggregating a substituted polyacetylene on the surface of the substrate 301.

This device can be used as an electronic device. For example, where a thin gold film is formed by vacuum vapor deposition from above, such as shown in FIG. 3A, a device having a structure shown in FIG. 3B can be obtained. Such a device has a sandwich structure in which a block polymer is sandwiched between the upper and lower electrodes. Because each polymer molecule is bonded to the upper and lower electrodes, a device is obtained in which no hopping occurs between molecular chains.

Furthermore, a device in accordance with the present invention can include the above-described block polymer, nanoparticles comprising a metallic substance selected from a metal, a metal oxide, and an alloy, and two or more electrodes. A part of a block structure of the block polymer is bonded to the nanoparticles comprising the metallic substance, and the block polymer and the nanoparticles comprising the metallic substance are connected to the electrode.

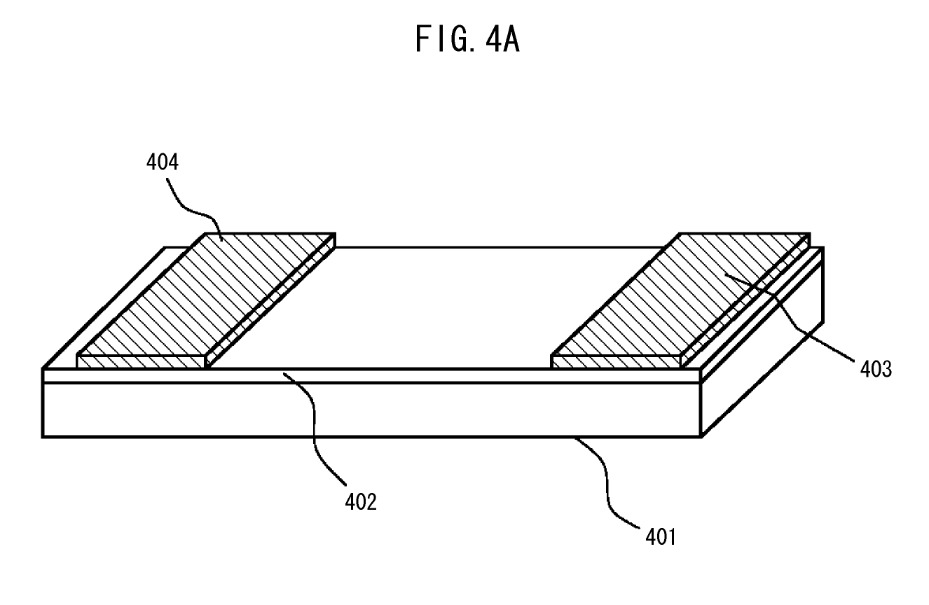

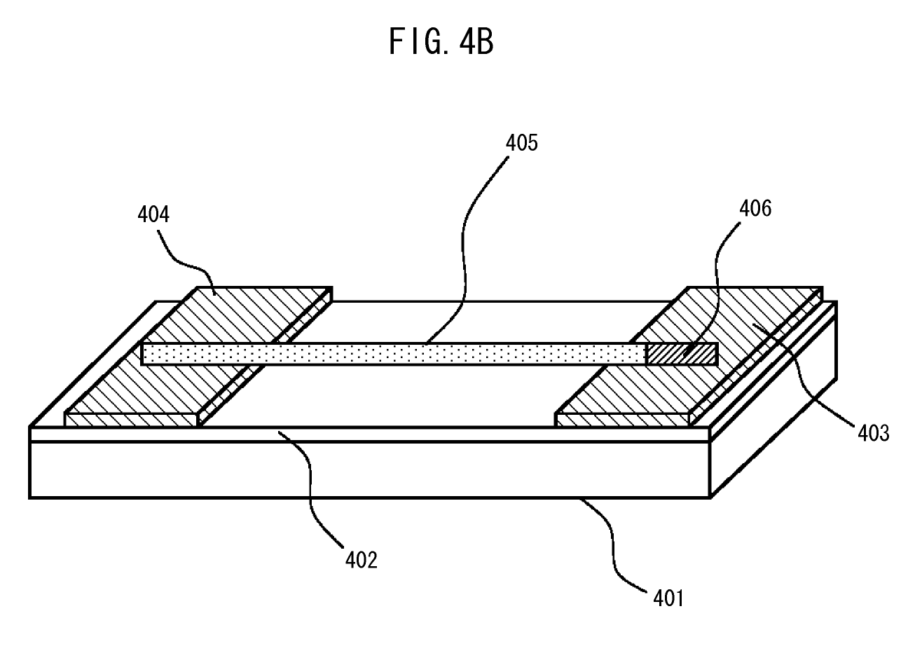

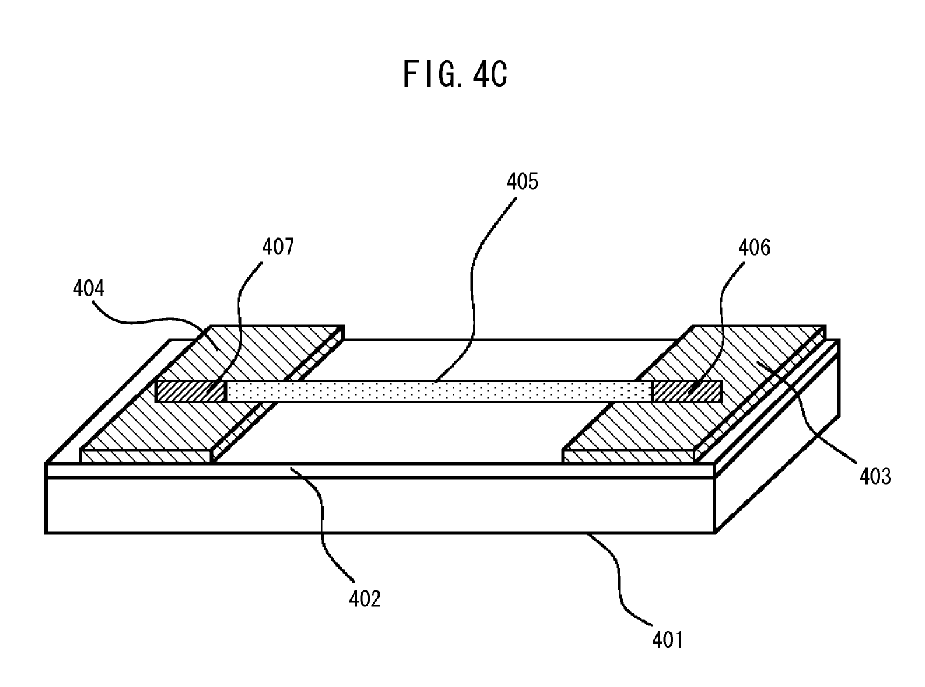

FIGS. 4A to 4C are schematic drawings illustrating another embodiment of a device in accordance with the present invention. FIG. 4A shows a conductive surface pattern. Reference numeral 401 represents a substrate, 402—an insulating film, and 403, 404—electrodes composed of a metallic substance. The electrode structure shown in FIG. 4B can be obtained with a certain probability by immersing an electrode substrate with a conductive surface pattern, such as shown in FIG. 4A, in a solution of a block polymer shown, for example, in FIG. 1A, thereby bonding the conductive surface to the bondable block portions. The aforementioned probability can be further increased by performing a substrate treatment and an orientation treatment by an external force or the like. In such an electrode structure, the block portion 406 that has an ability of bonding to metallic substance is bonded to the electrode 403, and a block portion 405 of the block polymer that has no ability of bonding to metallic substance is brought electrostatically into contact with the electrode 404, which is a counter electrode.

When the conductive pattern electrode substrate shown in FIG. 4A is immersed into a solution of a block polymer having two block portions that can bond to metallic substance, such as shown in FIG. 2 or FIG. 3B, the block portions bond to the electrodes. Thus, a device structure shown in FIG. 4C can be obtained. In such an electrode structure, the block portion 406 having an ability of bonding to metal specifies is bonded to the electrode 403, and the other block portion 407 having an ability of bonding to metallic substance is bonded to the electrode 404, which is a counter electrode.

### EXAMPLES

A method for producing a substituted polyacetylene in accordance with the present invention and a method for producing a device in which the substituted polyacetylene is covered on a metal electrode are described below.

Also described below are an example of producing a copolymer of polyphenylacetylene having a thiol group introduced in a side chain and an example of a device structure using the obtained copolymer.

### Example 1

### Method for Preparing a Rhodium Complex Catalyst

A total of 0.1 mol of triphenylphosphine and 0.01 mol of rhodium(norbornadiene)chloride dimer are placed in a test tube that has been sealed after depressurizing and purging with nitrogen, 5 mL of toluene is added as a solvent, and the system is held at 0° C. Then, 5 mL of a toluene solution of 1,1′,2-triphenylvinyllithium at a concentration of 8×10⁻³ mol/L is placed in the tube and stirring is performed for 1 hour at 0° C. to obtain a [rhodium(norbornadiene)((1,1′,2-triphenylvinyl)(triphenylphosphine)) complex solution.

### Method for Synthesizing a Polyacetylene Copolymer

A total of 10 mL of the rhodium complex solution at a concentration of 1.0×10⁻³ mol/L obtained by the above-described method is placed in a pear-shaped flask and a polymerization reaction is initiated by injecting a mixed solution of 0.3 g of 4-mercaptophenylacetylene and 15 mL of toluene. The reaction is conducted for 2 hours at 20° C. After the polymerization sufficiently advances, 0.3 g of 4-t-butylamidophenylacetylene is injected and the polymerization reaction is continued. The reaction is conducted for 2 hours at 20° C. The obtained polymer is washed with methanol, filtered and then vacuum-dried for 24 hours to obtain poly((4-mercaptophenylacetylene)-co-(4-t-butylamidophenylacetylene)), which is the target polyacetylene.

### Method for Producing a Device

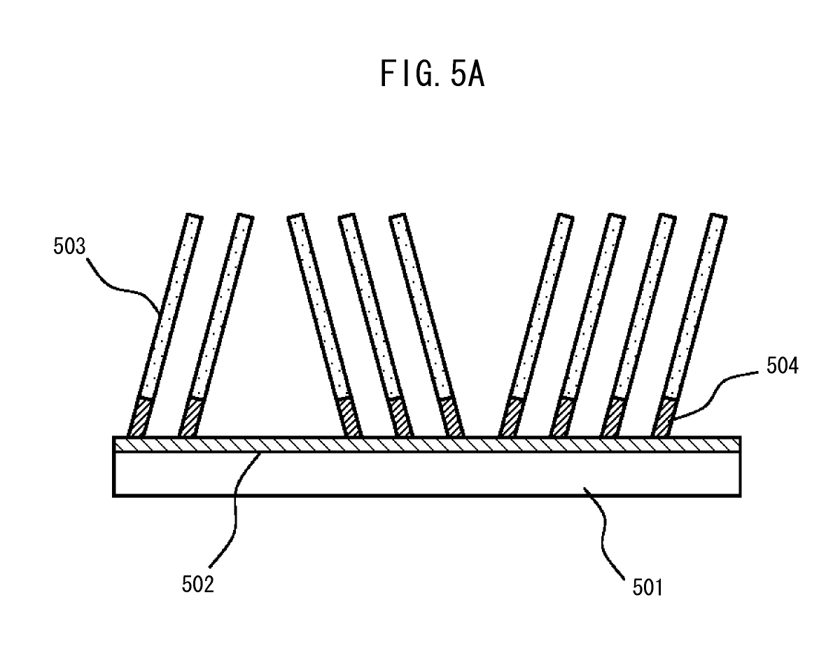

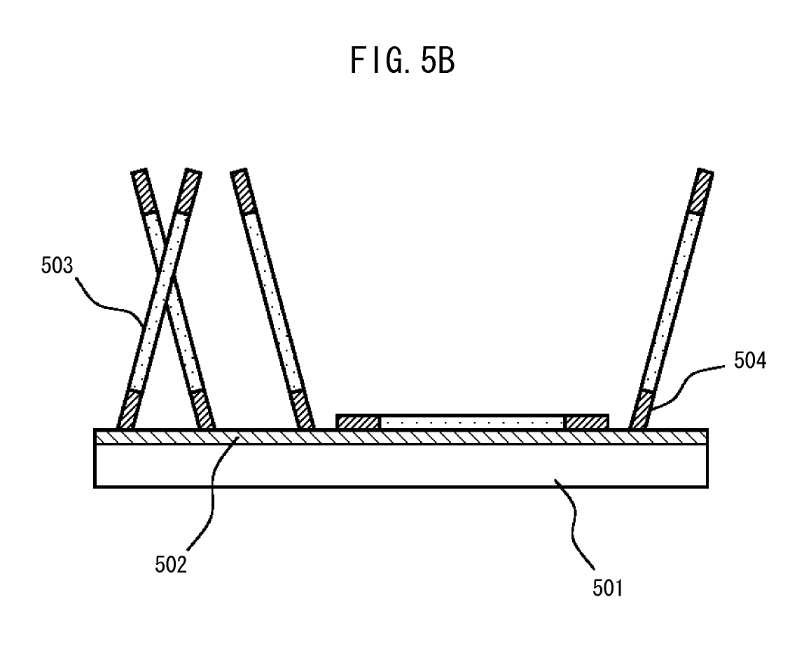

The obtained poly((4-mercaptophenylacetylene)-co-(4-t-butylamidophenylacetylene)) is dissolved in toluene and a solution at a concentration of 10⁻³ g/L is prepared. A mica substrate 501 having a thin gold film 502 on one surface is immersed in the solution and allowed to stand for 1 hour. The substrate is then washed with toluene and dried to obtain a composite device composed of the mica substrate and the polyacetylene block polymer 503 in which the (4-mercaptophenylacetylene) block 504 is bonded to the thin gold film 502 on the substrate 501, as shown in FIG. 5A.

### Example 2

### Method for Synthesizing a Triblock Copolymer

A total of 10 mL of the rhodium complex solution at a concentration of 1.0×10⁻³ mol/L obtained by the method described in Example 1 is placed in a pear-shaped flask. A polymerization reaction is initiated by injecting a mixed solution of 0.1 g of 4-mercaptophenylacetylene and 3.3 mL of toluene. The reaction is conducted for 30 minutes at 20° C. After the polymerization sufficiently advances, a mixed solution of 0.3 g of 4-t-butylamidophenylacetylene and 3.3 mL of toluene is injected and the polymerization reaction is further conducted for 1 hour at 20° C. After the polymerization sufficiently advances, a mixed solution of 0.1 g of 4-mercaptophenylacetylene and 3.3 mL of toluene is injected and the polymerization reaction is further conducted for 1 hour at 20° C. The obtained polymer is washed with methanol, filtered, and then vacuum-dried for 24 hours to obtain poly((4-mercaptophenylacetylene)-co-(4-t-butylamidophenylacetylene)-co-(4-mercaptophenylacetylene)), which is the target polyacetylene.

### Method for Producing a Device

The obtained poly((4-mercaptophenylacetylene)-co-(4-t-butylamidophenylacetylene)-co-(4-mercaptophenylacetylene)) is dissolved in toluene and a solution at a concentration of 10⁻³ g/L is prepared. A mica substrate 501 with gold vapor-deposited on one surface is immersed in the solution and allowed to stand for 1 hour. The substrate is then washed with toluene and dried to obtain a composite device in which a polyacetylene is bonded to a substrate, such as shown in FIG. 5B.

### Example 3

### Method for Fabricating a Nanoparticle-Polymer Device

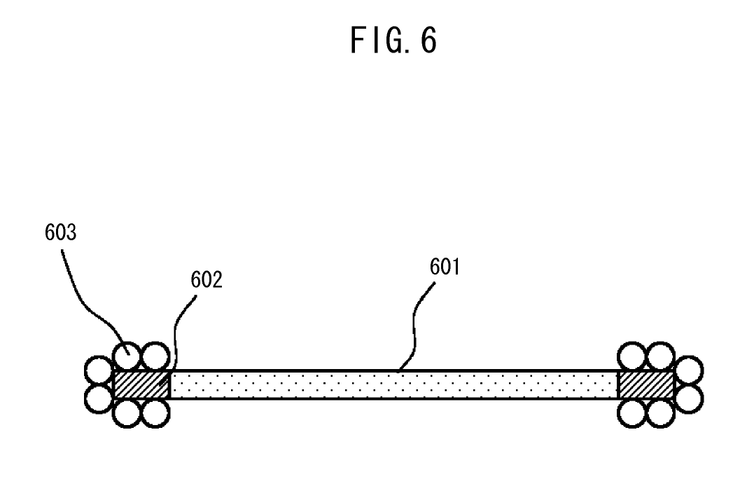

The polyphenylacetylene copolymer obtained by the method of Example 2 is dissolved in toluene and a solution at a concentration of 10⁻³ g/L is prepared. A dispersion of gold nanoparticles is added to the solution and the system is allowed to stand for 1 hour, followed by washing with toluene and drying. As a result, a complex device of gold nanoparticles 603 and a polyacetylene block polymer 601 having (4-mercaptophenylacetylene) blocks 602 bonded thereto is obtained, as shown in FIG. 6.

### Example 4

### Method for Fabricating a Device Structure

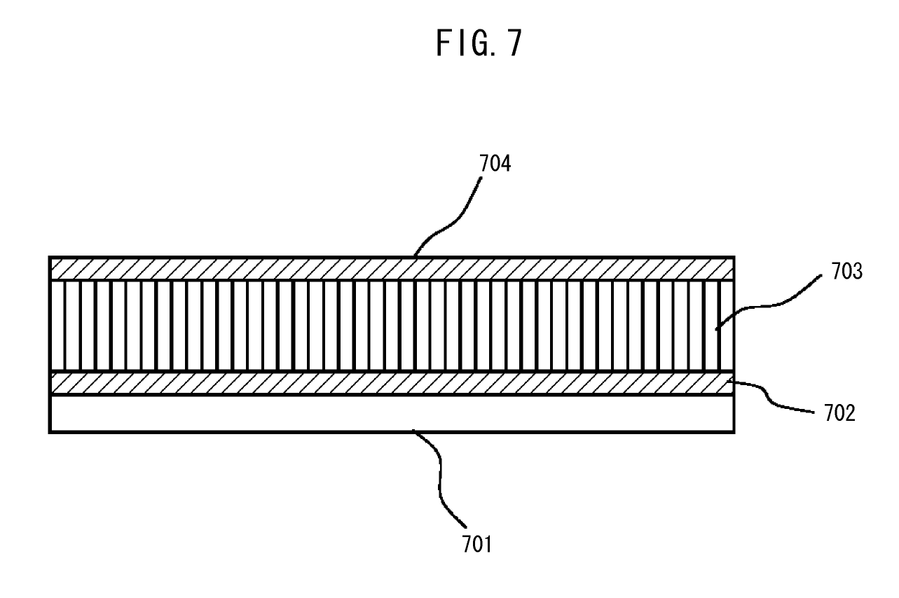

The device in this example is formed on a mica substrate 701 with a thin gold film 702 vapor-deposited on the surface thereof at a film thickness of 100 nm, as shown in FIG. 7. A structure in which a substituted polyacetylene is sandwiched between two thin gold film electrodes can be fabricated by producing a substituted polyacetylene film 703 by the method of Example 2 on the gold substrate and then vacuum vapor-depositing a thin gold film 704 thereupon.

### Example 5

### Method for Fabricating a Device Structure

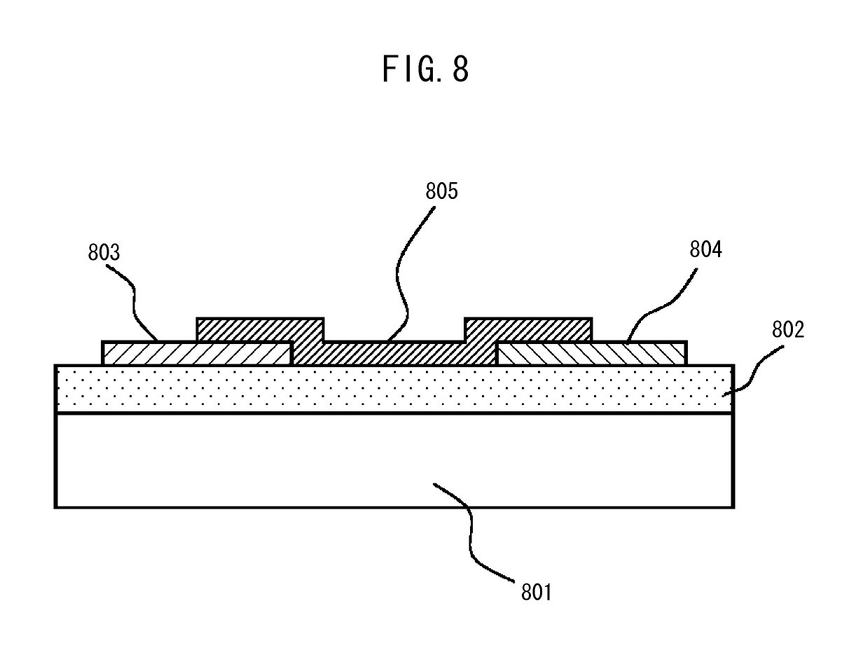

The device in this example is formed on a highly-doped Si substrate 801 that has a 100 nm thick thermal oxidation film 802 on the surface, such as shown in FIG. 8. The reference numerals 803 and 804 represent gold electrodes formed by lithography using an electron beam exposure. The distance between the electrodes is about 50 nm. The copolymer obtained in Example 1 is dissolved in 1.0 mL of chloroform to produce a solution that has a concentration of 1.0×10⁻³ wt. %. The solution is coated on the gold electrodes patterned on the silicon substrate by a spin coat method, thereby forming a copolymer layer 805. The length of the copolymer used in the present example is about 100 nm. A large number of molecules come into contact with both gold electrodes 803 and 804, and intermolecular hopping conduction between the gold electrodes 803 and 804 is inhibited.

In the present device, the Si substrate 801 operates as a gate electrode, and an electric current flowing between the gold electrodes 803 and 804 is controlled by the application of voltage to the substrate 801.

### Example 6

A nanoparticle-polyacetylene composite device is fabricated in the same manner as in Example 4, except that the polyacetylene of Example 4 is replaced with the nanoparticle-polyacetylene composite of Example 3.

### Example 7

A nanoparticle-polyacetylene composite device is fabricated in the same manner as in Example 5, except that the polyacetylene of Example 5 is replaced with the nanoparticle-polyacetylene composite of Example 3.

Because the composite in accordance with the present invention, in which a metallic substance is bonded to a block polymer, utilizes chemical bonding, electric bonding via the metallic substance is possible. Therefore, the composite can be used in an organic molecular device in which one molecule bridges a plurality of electrodes by connecting a pair of electrodes via a polymer chain of the block polymer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-217018, filed Aug. 31, 2007, which is hereby incorporated by reference herein in its entirety.

What is claimed is:

1. A block polymer having in at least a part thereof a block structure of a repeating unit that has in a side chain thereof an organic functional group capable of bonding to at least one metallic substance selected from the group consisting of a metal, a metal oxide, and an alloy,
wherein a polymer main chain of the block structure has a helical shape.

2. The block polymer according to claim 1, wherein the organic functional group is at least one selected from the group consisting of a thiol group, a sulfide group, a disulfide group, a thioacetyl group, an isocyanide group, a carboxylic acid group, and a phosphoric acid group.

3. The block polymer according to claim 1, wherein the metallic substance is gold, platinum, silicon, indium tin oxide, silicon oxide, or an alloy of gold and zinc.

4. The block polymer according to claim 1, wherein the polymer main chain of the block structure comprises a π-conjugated polymer.

5. A composite of a metal and a block polymer comprising:
a block polymer according to claim 1; and
a metallic substance selected from the group consisting of a metal, a metal oxide, and an alloy,
wherein a part of a block structure of the block polymer is bonded to the metallic substance.

6. The composite of a metal and a block polymer according to claim 5, wherein the block polymer is polyacetylene.

7. The composite of a metal and a block polymer according to claim 5, wherein the metallic substance is in a form of nanoparticles.

8. A device comprising:
a block polymer according to claim 1; and
an electrode comprising a metallic substance selected from the group consisting of a metal, a metal oxide, and an alloy,
wherein a part of a block structure of the block polymer is bonded to the metallic substance.

9. The device according to claim 8, wherein the block polymer is polyacetylene.

10. A device comprising:
a block polymer according to claim 1;
nanoparticles comprising a metallic substance selected from the group consisting of a metal, a metal oxide, and an alloy; and
two or more electrodes,
wherein a part of a block structure of the block polymer is bonded to the nanoparticles, and
wherein the block polymer and the nanoparticles are connected to the electrode.
